(19) United States
(12) Patent Application Publication
(10) Pub. No.: US 2014/0095022 A1
(43) Pub. Date: Apr. 3, 2014

(54) Active Suspension System

(71) Applicants: Thomas J. Cashman, Rowley, MA (US); Antonio Sangermano, II, Rindge, NH (US); Marc Hertzberg, Sudbury, MA (US)

(72) Inventors: Thomas J. Cashman, Rowley, MA (US); Antonio Sangermano, II, Rindge, NH (US); Marc Hertzberg, Sudbury, MA (US)

(21) Appl. No.: 13/644,038

(22) Filed: Oct. 3, 2012

(51) Int. Cl. B60G 17/018

(52) U.S. Cl. 701/37

(57) ABSTRACT

An active suspension system for a sprung mass. The suspension system has an electromagnetic motor that produces force on the sprung mass and that is powered by power from a power source. The motor has an armature, and a stator with coils. Motor drive electronics include a power amplifier that delivers power to the motor coils; the motor drive electronics are physically separate from the motor. There is a non-volatile digital memory circuit that stores motor commutation calibration data that represents a mapping of coil input current to resulting motor force output; the memory circuit is integrated with the motor. There can also be a clamp circuit that selectively provides actuator damping by electrically connecting the coils together; when present the clamp circuit is also integrated with the motor.

### FIELD

This disclosure relates to an active suspension system.

### BACKGROUND

Active suspension systems are used to counteract unwanted motions of a sprung mass. One such sprung mass is a suspended device. Suspended devices can be found in moving conveyances such as motor vehicles, trains, airplanes and the like. The suspended devices are suspended relative to a moving platform. One example is the suspension system for a motor vehicle that helps to smooth the ride. Another example is a suspended passenger seat in a motor vehicle.

Such active suspension systems can use an electromagnetic motor to produce force on the suspended device. The electromagnetic motor has electrical coils. A power source which is typically the vehicle battery is used to power the electromagnetic motor. A control system controls the flow of power to the motor to achieve a desired suspension result.

The electromagnetic motor can have a clamp feature that damps the motor. The clamp feature is accomplished with a clamp circuit that acts to electrically short circuit the coils such that the back electromotive force generated when the magnets in the armature move relative to the coils in the stator causes a current to flow in the shorted coils. By clamping the coils, the current resulting from this back electromotive force is dissipated in the resistance of the coils and a damping behavior results. Thus, a clamped actuator exhibits a damping behavior similar to a traditional shock-absorber.

The clamp circuit is typically located in the motor drive electronics module that is physically separate from the motor assembly; the drive electronics module and the motor assembly are connected by electrical wiring. With the clamp circuit physically separated from the motor, if the motor is not connected to the drive electronics the clamp feature is disabled. Without the clamp feature enabled, the un-damped motor armature can move more quickly than it can when the motor is damped. This quick motion can present a safety hazard to a person handling the motor. For example, a finger could be pinched by sudden movement of the un- damped armature relative to the stator. Further, if the wiring that connects the drive electronics to the motor assembly is disconnected or interrupted for any reason, the clamp feature is disabled and the suspension accomplished by clamping is also disabled.

In order for the electromagnetic motor to be properly controlled to deliver forces to the suspended device, before a motor is installed it is typically placed on a test bed and commutation calibration data comprising a mapping of input currents to output force is generated and stored in a non-volatile digital memory. The digital memory has been associated with the computer that is part of the drive electronics module that is separate from the motor assembly. This arrangement creates an inextricable tie between the drive electronics and the motor in that neither component is separately interchangeable without external re-programming of motor calibration data. Thus, if the motor needs to be replaced the calibration data for the new motor needs to be loaded into the calibration data memory in the drive electronics module.

### SUMMARY

An active suspension system can be used to counteract unwanted motions of a vibration isolation platform and any elements that are coupled to the platform. An active suspension system uses one or more electromagnetic actuators that can provide a linear output motion to help accomplish a desired suspension result. Examples of such electromagnetic actuators include linear motors and rotary motors that drive a transmission mechanism that converts rotary motion to linear motion. The electromagnetic actuators are typically supplied with energy from an existing electrical power source. In a vehicle or other conveyance, the energy source is typically the existing vehicle battery.

An aspect of this disclosure relates to the physical relocation of the motor commutation calibration data for the electromagnetic motor of an active suspension system from the drive electronics module to the electromagnetic motor assembly. This marries the motor calibration data to the motor, so that either the motor assembly or the drive electronics module can be replaced individually without the need to manage and re-program motor calibration data.

Another aspect of the disclosure relates to the relocation of the electromagnetic motor clamp circuit from the drive electronics to the motor assembly. As a result, if the electrical connection between the drive electronics and the motor assembly is interrupted for any reason, such as a broken cable or connector or a failed wiring crimp, the clamp function is not disabled. If the clamp circuit includes a normally on switch, a battery for backup power for the clamp circuit can be included as part of the motor assembly. In this way if the wiring connecting the drive electronics to the motor is interrupted, the clamp switches will remain powered by the battery so that the clamp function is not disabled.

In one example this disclosure features an active suspension system for a sprung mass. There is an electromagnetic motor that produces force on the sprung mass and that is powered by power from a power source. The motor comprises an armature, and a stator with coils. There are motor drive electronics comprising a power amplifier that delivers power to the motor coils; the motor drive electronics are physically separate from the motor. There is a non-volatile digital memory circuit that stores motor commutation calibration data comprising a mapping of coil input current to resulting motor force output; the memory circuit is integrated with the motor. The motor may be part of a motor assembly that comprises a motor housing, in which case the memory circuit may, for example, either be added to an existing printed circuit board of the motor assembly or located within or attached to the motor housing. The electromagnetic motor may be a linear motor, and the sprung mass may comprise a suspended device located in a conveyance. The conveyance may be a motor vehicle, and the suspended device may be a passenger seat of the motor vehicle.

The motor drive electronics may be responsive to the memory circuit, such that the power amplifier outputs power that has been previously determined to produce a desired motor output force. The active suspension system may further comprise a digital interface device that is integrated with the motor, wherein the memory circuit is adapted to communicate with the motor drive electronics through the digital interface device. The active suspension system may further comprise a clamp circuit that selectively provides actuator damping by electrically connecting the coils together; the clamp circuit may be integrated with the motor. The clamp circuit may comprise solid-state switches; the solid-state switches may be arranged such that they are in a normally on state that clamps the motor, wherein the on state is disabled during electrical operation of the motor. The active suspension may further comprise a battery integrated with the motor that selectively provides backup power to the clamp circuit.

The motor drive electronics may further comprise a processor that receives input from the memory circuit and the clamp circuit and outputs control signals that control the power amplifier and the clamp circuit. The power amplifier may be enabled to deliver power to the motor coils only when the clamp circuit communicates to the processor that the motor is unclamped. The clamp circuit may comprises clamp logic, wherein the processor outputs control signals that comprise a clamp release high and a clamp release low and these control signals are provided to the clamp logic. The clamp logic may interpret the control signals, determine the desired clamp state based on these control signals, and output a clamp state control signal to the clamp circuit that sets the clamp state such that the clamp is disabled only when the correct set of control signals are received. The clamp state may be confirmed via a clamp status signal that is provided from the clamp logic to the processor, wherein the processor in response then enables or inhibits the power amplifier.

Another example features an active suspension system for a passenger seat located in a motor vehicle. The system comprises an electromagnetic linear motor that produces force on the passenger seat and that is powered by power from a power source. The motor comprises an armature, and a stator with coils. There is a motor drive electronics module comprising a power amplifier that delivers power to the motor coils. The motor drive electronics module is physically separate from the motor. There is a non-volatile digital memory circuit that stores motor commutation calibration data comprising a mapping of coil input current to resulting motor force output. The memory circuit is integrated with the motor. The motor drive electronics module is responsive to the memory circuit, such that the power amplifier outputs power that has been previously determined to produce a desired motor output force. There is also a clamp circuit that selectively provides actuator damping by electrically connecting the coils together. The clamp circuit is integrated with the motor. The motor drive electronics module further comprises a processor that receives input from the memory circuit and the clamp circuit and outputs control signals that control the power amplifier and the clamp circuit. The power amplifier is enabled to deliver power to the motor coils only when the clamp circuit communicates to the processor that the motor is unclamped.

The clamp circuit may comprise clamp logic. The processor may output control signals that comprise a clamp release high and a clamp release low, wherein these control signals are provided to the clamp logic. The clamp logic then interprets the control signals, determines the desired clamp state based on these control signals, and outputs a clamp state control signal to the clamp circuit that sets the clamp state such that the clamp is disabled only when the correct set of control signals are received. The clamp state is confirmed via a clamp status signal that is provided from the clamp logic to the processor; the processor in response then enables or inhibits the power amplifier. The active suspension system may further include a digital interface device that is integrated with the motor, and a battery integrated with the motor that selectively provides backup power to the clamp circuit. The memory circuit is adapted to communicate with the motor drive electronics module through the digital interface device. The clamp circuit comprises solid-state switches that are arranged such that they are in a normally on state that clamps the motor; the on state is disabled during electrical operation of the motor. The motor is part of a motor assembly that comprises a motor housing, and the memory circuit is either added to an existing printed circuit board of the motor assembly or located within or attached to the motor housing.

### BRIEF DESCRIPTION OF THE DRAWINGS

FIG. 1 is a schematic diagram of an active suspension system for a sprung mass.

FIG. 2 is a more detailed schematic diagram of an active suspension system for a sprung mass.

FIG. 3 is a more detailed schematic diagram of an active suspension system for a sprung mass.

### DETAILED DESCRIPTION

It is desirable to arrange an active suspension system for a vehicle seat that includes an electromagnetic motor that provides force to help control the seat position. The motor is part of a motor assembly that can be removed, handled safely, and replaced without having to re-program the motor drive electronics. It is also desirable to arrange the motor assembly such that the clamping function can be enabled even if the motor assembly is not connected to the drive electronics; such an independently-operable clamp feature allows the clamp to work even if the cable connecting the drive electronics to the motor assembly is interrupted, and also allows the clamping function to be enabled before the motor assembly has been installed such as during motor test and calibration, shipment, and during the installation itself. Allowing the clamp feature to be enabled while it is handled by personnel helps to prevent possible injury due to unanticipated sudden motion of an un-damped motor armature relative to the stator.

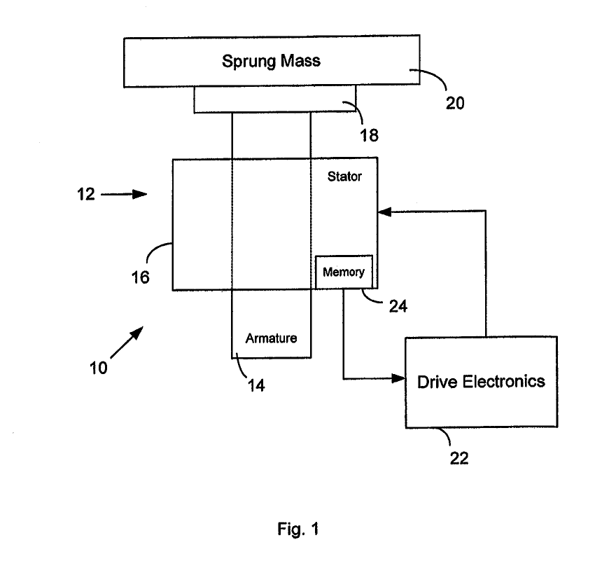

FIG. 1 is a schematic diagram of active suspension system 10 that is adapted to suspend sprung mass 20. System 10 includes electromagnetic motor assembly 12 that comprises stationary stator 16 that has electrical coils (not shown), and movable armature 14. Armature 14 carries structure 18 that interfaces with sprung mass 20. Motor drive electronics module 22 delivers power to the motor coils. Drive electronics module 22 includes the power supply and power electronics that drive the motor. Drive electronics module 22 is physically separate from motor assembly 12. Physically separating drive electronics module 22 from motor assembly 12 allows more flexibility in packaging, separates two heat sources (e.g., the power devices in the amplifier and the motor coils) so that they do not adversely affect each other, and allows simple field swap of either just the motor assembly or just the electronics, which reduces the cost of service.

Non-volatile digital memory circuit 24 is integrated with motor assembly 12. In one non-limiting embodiment, memory 24 can be an electrically erasable programmable read only memory (EEPROM) chip that is integrated with motor assembly 12, for example it can be added to an existing printed circuit board of the motor assembly, and/or located within or attached to the motor housing. Integrating memory 24 with motor assembly 12 ensures that the data stored by memory 24 is always physically associated with the motor. Memory 24 can store motor commutation calibration data that comprises a mapping of coil input currents to resulting motor force outputs. Drive electronics module 22 uses this calibration data stored by memory 24 to develop drive currents that are supplied to the motor coils and result in a desired force output. With this physical relocation of the motor commutation calibration data to the electromagnetic motor assembly, the motor calibration data is tied directly to the motor such that either the motor assembly or the drive electronics module can be replaced individually without the need to manage and re-program motor calibration data.

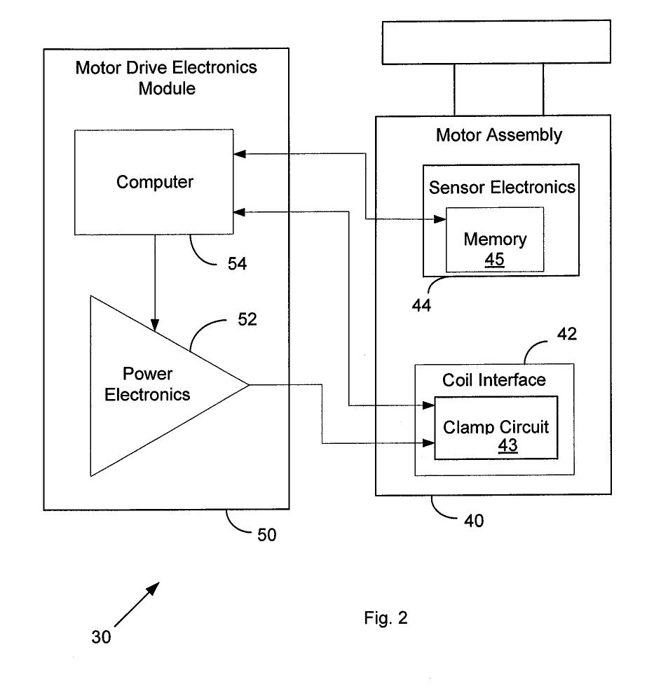

FIG. 2 schematically depicts active suspension system 30 that comprises motor assembly 40 and motor drive electronics module 50. In one non-limiting example, system 30 is used in a suspension system for a motor vehicle passenger seat, wherein the system is used to reduce or cancel unwanted seat motions such as vibrations caused by the roadway and the engine. Module 50 comprises a controller or computer 54 that controls the operation of power electronics 52. Power electronics 52 provides appropriate power to drive the armature of motor assembly 40. Power electronics 52 also supplies power to clamp circuit 43 that is an integral part of motor assembly 40.

Clamp circuit 43 comprises one or more digital switches that are on when power is provided to them (i.e., normally on). When the switches are on, they interconnect the motor coils via coil interface 42, to provide a clamping function to the motor. Thus, clamp circuit 43 is normally on such that the coils are clamped, which makes clamping the default function. The power to maintain the clamp circuit switches on can be supplied from an existing power source such as a vehicle battery, or a power source such as a battery integrated within the motor assembly. When the active suspension system is enabled to operate in its normal fashion, computer 54 provides control signals to clamp circuit 43 to disable its digital switches; this allows the coils of motor assembly 40 to be energized to accomplish a desired movement of the armature. Alternatively, clamp circuit 43 could use normally closed switches; normally closed semiconductor switches tend to be substantially more expensive and take up more space than normally open switches and so are not preferred.

Non-volatile digital memory circuit 45 is also integrated with motor assembly 40. Memory 45 stores the motor commutation calibration data as described above. In this non-limiting embodiment, motor assembly 40 already comprises sensor electronics module 44 which includes one or more of a position sensor and a vibration sensor, both of which can be used in the motor control scheme. In one non-limiting example, a position sensor can sense the position of a motor vehicle seat relative to the floor to which it is mounted and an accelerometer can be used to sense seat vibrations; the sensor output signals can be used in the controller to control seat motions so as to counteract unwanted motions. Sensor electronics module 44 includes a digital interface to allow it to communicate aspects such as sensor data with computer 54. Memory 45 is co-located with sensor electronics 44; in this case motor assembly 40 already includes a position sensor printed circuit board (PCB) that has a digital interface so as to communicate with computer 54 and is integrated with the motor (i.e., it is part of sensor electronics module 44 that is physically coupled to the motor assembly), and the EEPROM is added to that board. Alternatively the EEPROM could be added to the clamp PCB, but since the clamp PCB does not already have a digital interface one would need to be added so this arrangement is not preferred. During initialization of the motor drive system, computer 54 will download the motor calibration data stored in memory 45. Computer 54 then uses this data when system 30 is in active use, to properly energize the motor to accomplish a desired suspension of the suspended device.

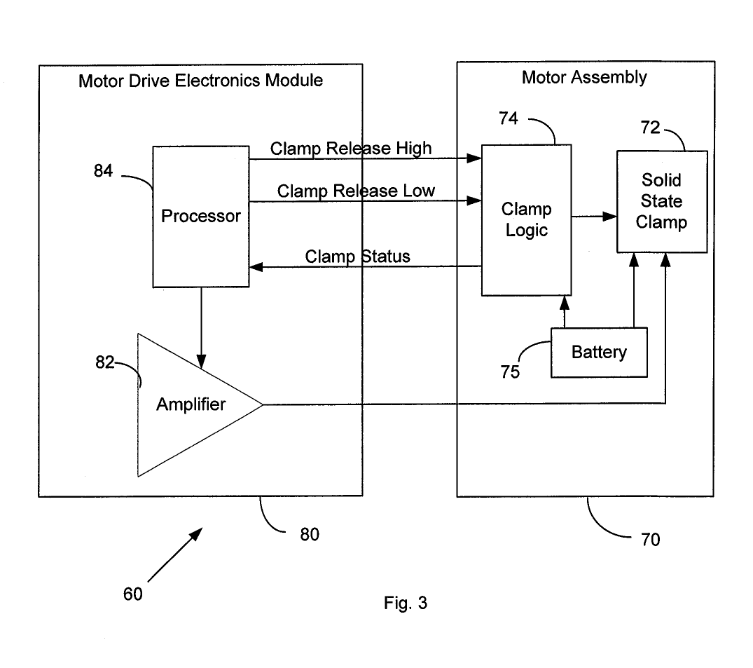

FIG. 3 is a more detailed schematic block diagram of active suspension system 60 that comprises motor assembly 70 and motor drive electronics module 80. In one non-limiting example, system 60 is used in a suspension system for a motor vehicle passenger seat, wherein the system is used to reduce or cancel unwanted seat motions such as vibrations caused by the roadway and the engine. FIG. 3 gives more detail of an example of a clamp configuration and operation. Solid state clamp 72 is integrated with motor assembly 70 and may comprise one or more solid state switches. Clamp logic 74 is also integrated with motor assembly 70 and provides control signals to clamp 72 to control the on or off state of its solid state switches.

Motor drive electronics module 80 is physically separate from motor assembly 70. Module 80 includes processor 84 that outputs control signals that comprise two control lines: clamp release high and clamp release low. These control signals are provided to clamp logic 74. Logic 74 interprets the control lines, determines the desired clamp state based on these inputs, and outputs a control signal to clamp 72 that sets its state such that clamp 72 is disabled only when the correct set of inputs are received. This complementary logic provides a robust method to open and close the clamp, which reduces the risk of a single point failure, e.g., where a single logic line could be stuck high or low and falsely change the clamp state. The clamp state is confirmed via a clamp status signal that is provided back to processor 84. Processor 84 then enables or inhibits amplifier 82 that powers clamp 72. The confirmation of the clamp state allows amplifier 82 to be turned on safely only when the clamp is off. One advantage of this operation is that it ameliorates the risk of inadvertently providing a short circuit path from the power supply, through the amplifier, through the clamp, to ground.

Clamp 72 can be implemented in many ways, for example, by using normally on or normally off digital semiconductor switches such as metal-oxide-semiconductor field-effect transistors (MOSFETs). Other solid state devices that could be used include insulated-gate bipolar transistors (IGBTs), bipolar junction transistors (BJTs) and solid state relays, for example. Back-up battery 75 is able to supply necessary power to clamp 72 and clamp logic 74 such that the clamp function can operate without power from electronics module 80. Also, the clamp switches could be driven in other manners such by including a large capacitor as an energy storage device, using the back electromotive force of the actuator, or other energy harvesting methodologies such as piezoelectric devices, for example.

Although features of the disclosure are shown in some drawings and not others, this is not a limitation of the scope of the disclosure as other examples will occur to those skilled in the field and are within the scope of the claims.

What is claimed is:

1. An active suspension system for a sprung mass, comprising:
an electromagnetic motor that produces force on the sprung mass and that is powered by power from a power source, the motor comprising an armature and a stator with coils;
motor drive electronics comprising a power amplifier that delivers power to the motor coils, wherein the motor drive electronics are physically separate from the motor; and
a non-volatile digital memory circuit that stores motor commutation calibration data comprising a mapping of coil input current to resulting motor force output, wherein the memory circuit is integrated with the motor.

2. The active suspension system of claim 1 wherein the motor drive electronics are responsive to the memory circuit, such that the power amplifier outputs power that has been previously determined to produce a desired motor output force.

3. The active suspension system of claim 2 further comprising a digital interface device that is integrated with the motor, wherein the memory circuit is adapted to communicate with the motor drive electronics through the digital interface device.

4. The active suspension system of claim 1 further comprising a clamp circuit that selectively provides actuator damping by electrically connecting the coils together.

5. The active suspension system of claim 4 wherein the clamp circuit is integrated with the motor.

6. The active suspension system of claim 5 wherein the clamp circuit comprises solid-state switches.

7. The active suspension system of claim 6 wherein the solid-state switches are arranged such that they are in a normally on state that clamps the motor, wherein the on state is disabled during electrical operation of the motor.

8. The active suspension of claim 7 further comprising a battery integrated with the motor that selectively provides backup power to the clamp circuit.

9. The active suspension system of claim 5 wherein the motor drive electronics further comprise a processor that receives input from the memory circuit and the clamp circuit and outputs control signals that control the power amplifier and the clamp circuit.

10. The active suspension system of claim 9 wherein the power amplifier is enabled to deliver power to the motor coils only when the clamp circuit communicates to the processor that the motor is unclamped.

11. The active suspension system of claim 10 wherein the clamp circuit comprises clamp logic, wherein the processor outputs control signals that comprise a clamp release high and a clamp release low and these control signals are provided to the clamp logic.

12. The active suspension system of claim 11 wherein the clamp logic interprets the control signals, determines the desired clamp state based on these control signals, and outputs a clamp state control signal to the clamp circuit that sets the clamp state such that the clamp is disabled only when the correct set of control signals are received.

13. The active suspension system of claim 12 wherein the clamp state is confirmed via a clamp status signal that is provided from the clamp logic to the processor, wherein the processor in response then enables or inhibits the power amplifier.

14. The active suspension system of claim 1 wherein the electromagnetic motor is a linear motor and the sprung mass comprises a suspended device located in a conveyance.

15. The active suspension system of claim 14 wherein the conveyance comprises a motor vehicle and the suspended device comprises a passenger seat of the motor vehicle.

16. The active suspension system of claim 1 wherein the motor is part of a motor assembly that comprises a motor housing, and wherein the memory circuit is either added to an existing printed circuit board of the motor assembly or located within or attached to the motor housing.

17. An active suspension system for a passenger seat located in a motor vehicle, comprising:
an electromagnetic linear motor that produces force on the passenger seat and that is powered by power from a power source, the motor comprising an armature and a stator with coils;
a motor drive electronics module comprising a power amplifier that delivers power to the motor coils, wherein the motor drive electronics module is physically separate from the motor;
a non-volatile digital memory circuit that stores motor commutation calibration data comprising a mapping of coil input current to resulting motor force output, wherein the memory circuit is integrated with the motor;
wherein the motor drive electronics module is responsive to the memory circuit, such that the power amplifier outputs power that has been previously determined to produce a desired motor output force;
a clamp circuit that selectively provides actuator damping by electrically connecting the coils together, wherein the clamp circuit is integrated with the motor;
wherein the motor drive electronics module further comprises a processor that receives input from the memory circuit and the clamp circuit and outputs control signals that control the power amplifier and the clamp circuit, wherein the power amplifier is enabled to deliver power to the motor coils only when the clamp circuit communicates to the processor that the motor is unclamped.

18. The active suspension system of claim 17 wherein the clamp circuit comprises clamp logic, wherein the processor outputs control signals that comprise a clamp release high and a clamp release low and these control signals are provided to the clamp logic, wherein the clamp logic interprets the control signals, determines the desired clamp state based on these control signals, and outputs a clamp state control signal to the clamp circuit that sets the clamp state such that the clamp is disabled only when the correct set of control signals are received, and wherein the clamp state is confirmed via a clamp status signal that is provided from the clamp logic to the processor, wherein the processor in response then enables or inhibits the power amplifier.

19. The active suspension system of claim 18 further comprising a digital interface device that is integrated with the motor and a battery integrated with the motor that selectively provides backup power to the clamp circuit, wherein the memory circuit is adapted to communicate with the motor drive electronics through the digital interface device, wherein the clamp circuit comprises solid-state switches that are arranged such that they are in a normally on state that clamps the motor, wherein the on state is disabled during electrical operation of the motor, wherein the motor is part of a motor assembly that comprises a motor housing, and wherein the memory circuit is either added to an existing printed circuit board of the motor assembly or located within or attached to the motor housing.
